(19) United States
(12) Patent Application Publication
(10) Pub. No.: US 2026/0088047 A1
(43) Pub. Date: Mar. 26, 2026

(54) BEGINNING OF WRAP DATA SET READING AND WRITING FOR TAPE DRIVES

(71) Applicant: International Business Machines Corporation, Armonk, NY (US)

(72) Inventors: Tsuyoshi Miyamura, Yokohama-shi (JP); SETSUKO MASUDA, Toshima-ku (JP)

(21) Appl. No.: 18/892,596

(22) Filed: Sep. 23, 2024

(51) Int. Cl. G11B 5/55; G11B 5/02

(52) U.S. Cl. CPC G11B 5/5508; G11B 5/02

(57) ABSTRACT

Beginning of wrap (BOW) data set reading and writing for tape drives is provided. In response to reaching an end of wrap (EOW) while writing to tape, a tape directory (TD) is updated to include first data set information for a first data set written at the EOW of a first wrap. A second data set is written using normal write procedure from a BOW of a second wrap, the second wrap following the first wrap. The first data set information is overwritten with second data set information for the second data set written at BOW. When reading a BOW data set from tape, data set information is read from a TD. Based on determining whether the data set information corresponds to a BOW data set, a target Data Set ID and a target Tape Write Pass are set for reading the BOW data set.

### BACKGROUND

The present disclosure relates to data storage systems, and more specifically, to magnetic tape data storage systems.

A linear tape drive allocates data on a tape in a longitudinal direction and records the data from the beginning of the tape to the end, then shifts the position slightly in the lateral direction of the tape, and then records data to the tape in the opposite longitudinal direction. The linear tape drive repeats this reciprocating operation several times with shifting in the lateral direction of the tape.

### SUMMARY

According to embodiments of the present disclosure, a method for beginning of wrap (BOW) data set writing to tape is provided. The method includes, in response to reaching an end of wrap (EOW) while writing to tape, updating a tape directory (TD) to include first data set information for a first data set written at the EOW of a first wrap. The method further includes writing a second data set using normal write procedure from a BOW of a second wrap, the second wrap following the first wrap. The method further includes overwriting, in the tape directory, the first data set information for the first data set written at the EOW with second data set information for the second data set written at BOW.

According to further embodiments of the present disclosure, a method for reading a data set from beginning of wrap (BOW) from tape is provided. The method includes reading data set information from a tape directory (TD), the data set information including a first Data Set ID and first Tape Write Pass. The method further includes, in response to determining that the data set information corresponds to a BOW data set, setting a target Data Set ID to the first Data Set ID and a target Tape Write Pass to the first Tape Write Pass. The method further includes reading the BOW data set from tape using the target Data Set ID and the target Tape Write Pass.

According to further embodiments of the present disclosure, a tape storage system having a tape drive configured to perform the above methods is provided.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example layout of wraps on a tape medium, according to embodiments.

FIG. 2 depicts a block diagram of an example computing environment, according to embodiments.

FIG. 3 depicts a block diagram of an example computer system, according to embodiments.

FIG. 4 depicts a block diagram of an example tape data storage drive, according to embodiments.

FIG. 5 depicts a flowchart of an example method for beginning of wrap data set writing, according to embodiments.

FIG. 6 depicts a flowchart of an example method for reading data sets from beginning of wrap, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to tape-based data storage, and more particular aspects relate to tape drive reading and writing when a write error occurs. While the present disclosure is not necessarily limited to such applications, various aspects of the disclosure may be appreciated through a discussion of various examples using this context.

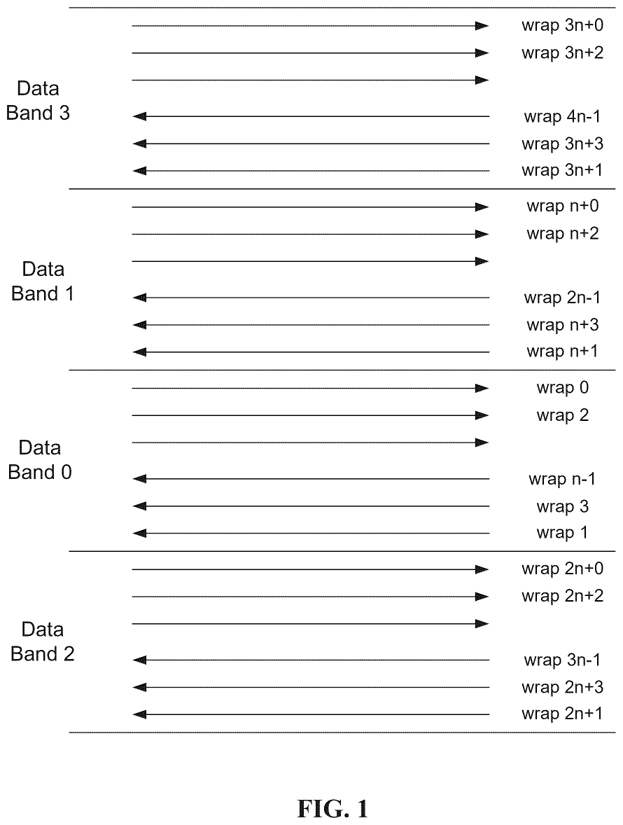

Tape drives write data linearly from the beginning of the tape to the end of the tape or the end of the tape to the beginning of the tape along each wrap region which divides the tape width into multiple areas. The data area width of each track on a wrap in the tape width direction is called track pitch. As shown in FIG. 1, the tape drive writes data on tracks running along the even wraps from the beginning of the tape to the end of the tape (forward direction), whereas it writes data on tracks along the odd wraps from the end of the tape to the beginning of the tape (backward direction).

Because tape drives write data from the beginning of the tape to the end of it, they are known as a sequential device. If new data is written from the middle of pre-written data sets, the drive cannot read back the new data set which has a larger data set number than the pre-written ones. A record is the unit that the host writes data to the tape drive. The records that are written to the tape drive are compressed by a compression engine of the tape drive and stored on a memory buffer temporarily. Once the compressed data size exceeds a data set size, the tape drive writes the data to the tape by the unit of a data set. A data set is divided into 64 sub data sets.

Each sub data set is divided into nearly 200 Code Objects (CO). COs are written on multiple tracks in parallel.

At the end of the user data sets, the tape drive writes a special type of data set called End of Data Set (EOD) to indicate that there is not a further data set on the tape. The physical position of the EOD is recorded in a non-volatile memory called cartridge memory (CM) embedded on the cartridge, and the tape drive can navigate to the location of the EOD to append new user data to the tape.

There are two kinds of identification to identify a data set. First, there is a data set ID whose value is set to 1 at the beginning of the tape (BOT) and increments for each data set. The other is a Tape Write Pass whose value is set to 1 when shipped and increments when an old data set is overwritten. The Tape Write Pass will never be cleared to ensure that latest data set has the largest value among all the data sets. When the tape drive reads new and old data set fragments, it can pick only the latest fragments by using Tape Write Pass.

The tape drive must move to a target data location that it wants to read or overwrite with new data when the host requests to read data from the tape or to write new data to the tape. The process to move to the target data location is called reposition.

The reposition request is made using the record number of the file mark number. The file mark is a delimiter of each file on the tape which contains multiple records. The tape drive does not know the location that the record or file mark are physically written on the tape. The tape drive utilizes a mechanism of Tape Directory (TD) to roughly identify the target record location. The TD divides a wrap into two regions and records the data set number and its Tape Write Pass, the last record number and file marks of the region, and the number of records and file marks recorded in the region.

Generally, tape format defines a first rule (rule-1) that the tape drive shall write a data set within 4 meters from the end of the last previously written data set. It also defines a second rule (rule-2) that a certain number of COs shall be written to the tape continuously. Rule-2 is applied so that an old data set is not mistakenly read back when old data sets with smaller Tape Write Passes are overwritten by a new data set with a larger Tape Write Pass. If COs with a larger Tape Write Pass exist at the end location of the previous data set that can be read, the tape drive won't read older data sets from the tape despite remaining COs that were written in the rear position on the tape. In addition to rule-1, the rule-2 is applied when an existing data set is overwritten by new one. After writing a data set by append, writing of the following data sets does not follow rule-2. As used herein, the way of writing data which follows only rule-1 is called “normal write.”

The tape drive can overwrite new records at an existing record location, which is called append. Append starts writing new data sets from the end longitudinal position (LPOS) of the previous data set of the overwritten data set. By writing from the location immediately, the old data is completely overwritten so that the old data cannot be mistakenly read. But if the tape drive's head is degraded by the usage, or if magnetic debris accumulate on the tape surface, the drive cannot position the write head on track correctly. In this case, the drive stops writing until the head is on the track. The drive keeps running without writing on the tape to adjust the head position until it is on the track. The drive can read back the new data set even when it was written at a later location than older data set by comparing the Tape Write Pass of the previous data set to the new data set. But an append data set does not have any previous data set with the same Tape Write Pass. This means that the overwritten data set can be returned to the host. In order to avoid the situation, append is required to write at least a certain number of data particles (fragments) continuously from the end LPOS of the previous data set. When the new fragments with newer Tape Write Pass are read at the beginning of a read operation, the overwritten data set can be discarded as its Tape Write Pass is smaller than newer data set.

When the tape medium is worn out or has accumulated debris, the drive may be unable to follow on the track at the location. Despite multiple write attempts, if the tape drive cannot start writing from the location, the drive can enter a Suspended Append Write (SAW) mode. The tape drive records the data set ID and Tape Write Pass in CM, and then it writes the data set not right at the location, but away from the location. When the drive reads a data set, it checks the CM to determine whether the data set was written by SAW. If so, the drive discards the older data set and attempts read again with the Tape Write Pass.

When the tape drive writes a data set from the beginning of wrap (BOW), it writes the data set under an append condition, which means the tape drive must write a certain number of fragments continuously from the BOW location. The number of counts the head runs at BOT becomes much larger than at the different locations because the tape drive head turns around at BOW. This causes of degradation of the tape surface near the BOW location. It is more difficult to meet the append condition on a degraded tape surface like at BOW than clean surface. This leads to retrying append from BOW several times, followed by writing data using the SAW mechanism. There are two problems with this; the region of SAW in CM is limited, and the write performance drops due to write retries until the drive switches from append to SAW.

Embodiments of the present disclosure provide a new mechanism to write data sets from BOW without using the append (i.e., writing at least a certain number of fragments continuously from BOW) or SAW mechanism.

According to embodiments, the tape drive writes a data set at BOW using normal write criteria instead of append criteria. When a data set is written at end of wrap (EOW), the tape drive records the data set ID and tape write pass of the data set in the TD. When a data set is written at BOW of the next wrap, the tape drive overwrites the data set ID field and tape write pass field in the TD for the EOW data set of the previous wrap with the data set ID field and tape write pass for the new data set written at BOW. The tape drive may record a flag in the TD to distinguish whether the data set ID and the tape write pass are for a data set written at EOW or BOW.

In some embodiments, the tape drive also writes a format information dataset (FID) using normal write criteria instead of append criteria. When the FID is written at BOW of the first wrap of a partition, the data set ID is confirmed as 0 and the tape write pass for the FID is updated in an FID page in the CM.

In existing tape drives, the following information is stored in the TD:
Tape Write Pass: The tape write pass of the data set written at the end of this entry;
Data Set ID: The data set number of the data set written at the end of this entry; and
Count/File Mark Count: The number of records or file marks recorded in the region of this entry. This value may be used to identify the TD region that contains the data set that stores the target record or file mark.

In some embodiments of the present disclosure, the definition of Tape Write Pass and Data Set ID may be changed as follows to support the methods of the present disclosure:
Tape Write Pass: The tape write pass of the data set written at the end of this entry, or the tape write pass of the data set written at the beginning of the next entry;
Data Set ID: The data set number of the data set written at the end of this entry, or the data set number of the data set written at the beginning of the next entry; and
Identification Flag: The flag indicates that the Tape Write Pass and the Data Set ID above are the information of the data set written at the end of this entry or the beginning of the next entry.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as tape module 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

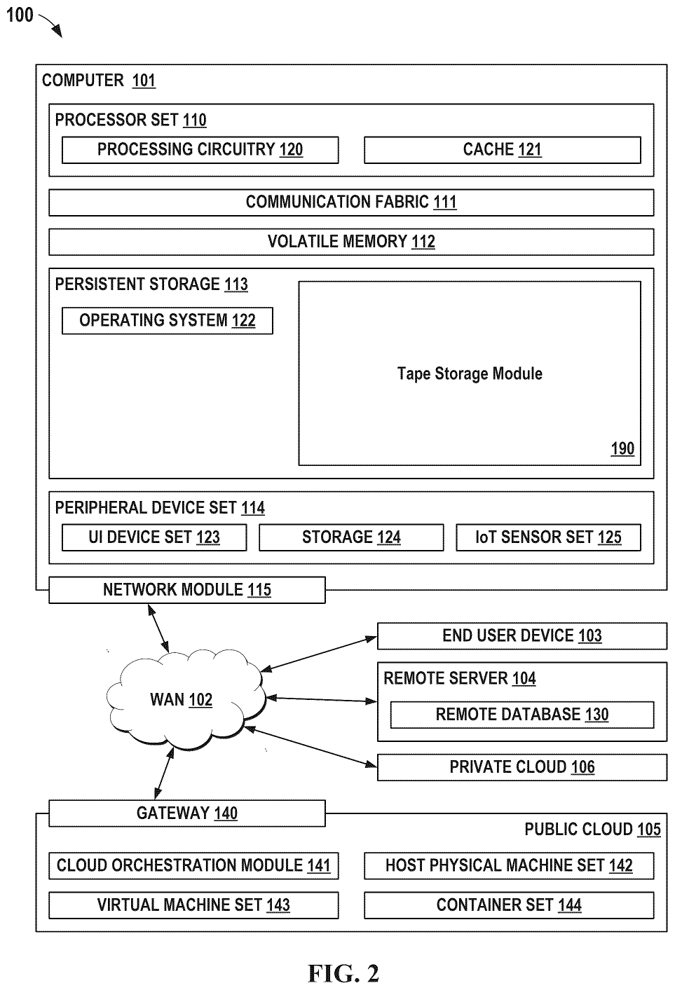

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 2. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Storage 124 may include a tape storage system. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104. In some embodiments, remote server 104 may include a tape storage system.

PUBLIC CLOUD 105 is any computer system available for use by multiple entities that provides on-demand availability of computer system resources and/or other computer capabilities, especially data storage (cloud storage) and computing power, without direct active management by the user. In some embodiments, public cloud 105 may include a tape storage system. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. In some embodiments, private cloud 106 may include a tape storage system. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

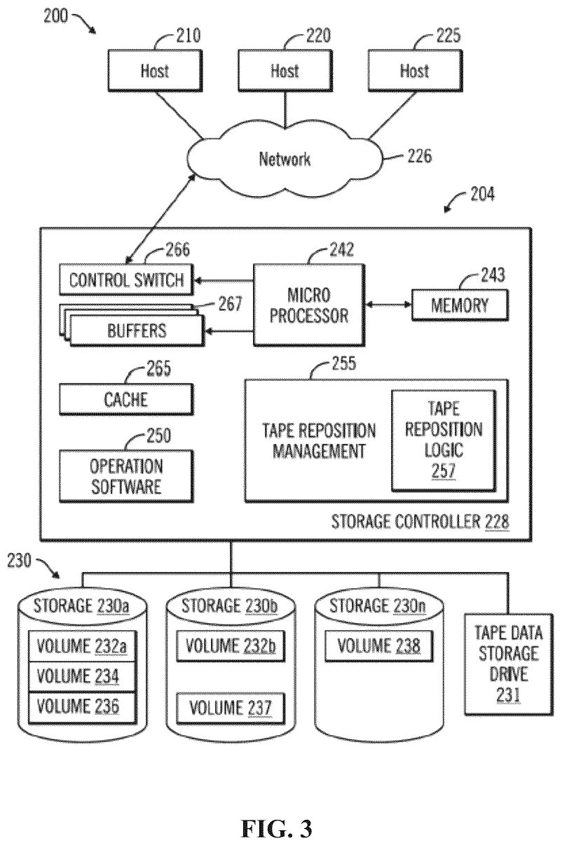

Referring now to FIG. 3, a block diagram of an example computer system 200 showing a hardware and software structure of a data storage system 204 is depicted. Host computers 210, 220, 225, are shown, each acting as a central processing unit for performing data processing as part of the computer system 200 which includes a data storage system 204. The hosts (physical or virtual devices), 210, 220, and 225 may be one or more physical devices or logical devices to accomplish the purposes of an embodiment of the present disclosure.

A Network connection 226 may be a fiber channel fabric, a fiber channel point to point link, a fiber channel over ethernet fabric or point to point link, a FICON or ESCON I/O interface, any other I/O interface type, a wireless network, a wired network, a LAN, a WAN, heterogeneous, homogeneous, public (i.e., the Internet), private, or any combination thereof. The hosts, 210, 220, and 225 may be local or distributed among one or more locations and may be equipped with any type of fabric (or fabric channel) (not shown in FIG. 3) or network adapter to the storage controller 228, such as Fibre channel, FICON, ESCON, Ethernet, fiber optic, wireless, or coaxial adapters. Data storage system 204 is accordingly equipped with a suitable fabric (not shown in FIG. 3) or network to communicate. Data storage system 204 is depicted in FIG. 3 comprising storage controller 228, and storage 230 including tape data storage drive 231 controlled by the storage controller 228.

Storage 230a ,230b. 230n of storage 230 may be physically comprised of one or more storage devices, such as storage arrays. A storage array is a logical grouping of individual storage devices, such as a hard disk or a tape data storage drive. In certain embodiments, one or more of storage 230a, 230b. 230n is comprised of a JBOD (Just a Bunch of Disks) array or a RAID (Redundant Array of Independent Disks) array. A collection of physical storage arrays may be further combined to form a rank, which dissociates the physical storage from the logical configuration. The storage space in a rank may be allocated into logical volumes, which define the storage location specified in a write/read request.

In one embodiment, by way of example only, the storage system as shown in FIG. 2 may include a logical volume, or simply “volume,” and may have different kinds of allocations. Storage 230a, 230b and 230n are shown as ranks in data storage system 204, and are referred to herein as rank 230a, 230b and 230n. Ranks may be local to data storage system 204, or may be located at a physically remote location. In other words, a local storage controller may connect with a remote storage controller and manage storage at the remote location. Rank 230a is shown configured with two entire volumes, 234 and 236, as well as one partial volume 232a. Rank 230b is shown with another partial volume 232b and a full volume 237. Thus volume 232 is allocated across ranks 230a and 230b. Rank 230n is shown as being fully allocated to volume 238—that is, rank 230n refers to the entire physical storage for volume 238. From the above examples, it will be appreciated that a rank may be configured to include one or more partial and/or entire volumes. Volumes and ranks may further be divided into so-called “tracks,” which represent a fixed block of storage. A track is therefore associated with a given volume and may be given a given rank.

To facilitate a clearer understanding of aspects of the present disclosure, storage controller 228 is shown in FIG. 3 as a single processing unit, including a microprocessor 242, system memory 243 which may include nonvolatile storage (“NVS”) described in more detail below. It is noted that in some embodiments, storage controller 228 is comprised of multiple processing units, each with their own processor complex and system memory, and interconnected by a dedicated network within data storage system 204. In some embodiments, the devices included in storage 230 may be connected in a loop architecture.

Storage controller 228 manages storage 230 and facilitates the processing of write and read requests intended for storage 230. The system memory 243 of storage controller 228 stores program instructions and data, which the microprocessor 242 may access for executing functions and methods of an embodiment of the present disclosure for executing and managing storage 230 as described herein. In some embodiments, system memory 243 includes, in association with, or in communication with the operation software 250, tape reposition management 255 for performing methods and operations employing reposition management. One aspect of the tape reposition management 255 is to control tape reposition logic 257 which controls the position of the tape of a tape data storage drive. Although the tape reposition logic 257 is depicted as a component of the tape reposition management 255, it is appreciated that the tape reposition logic 257 may be located in other components of the system such as one or more of the storage controller 228, a host 210-225, network 226, and tape storage drive 231. In a similar manner, although the logic of the tape reposition management 255 is depicted as a component of the storage controller 228, it is appreciated that the tape reposition management 255 may be located in other components of the system such as one or more of the tape storage drive 231, a host 210-225, and a network 226. Thus, tape reposition management 255 may be implemented with one or more of hardware, software, and firmware, alone or in combination.

As shown in FIG. 2, system memory 243 may also include or be in communication with a cache 265 for storage 230, also referred to herein as a “cache memory”, for buffering “write data” and “read data”, which respectively refer to write/read requests and their associated data. In one embodiment, cache 265 is allocated in a device external to system memory 243, yet remains accessible by microprocessor 242 and may serve to provide additional security against data loss, in addition to carrying out the operations as described in herein.

In some embodiments, cache 265 is implemented with a volatile memory and nonvolatile memory and coupled to microprocessor 242 via a local bus (not shown in FIG. 2) for enhanced performance of data storage system 204. An NVS portion of the memory 243 included in data storage controller is accessible by microprocessor 242 and serves to provide additional support for operations and execution of an embodiment of the present disclosure as described in other figures. The NVS may also referred to as a “persistent” cache, or “cache memory” and is implemented with nonvolatile memory that may or may not utilize external power to retain data stored therein. The NVS may be stored in and with the cache 265 for any purposes suited to accomplish the objectives of an embodiment of the present disclosure. In some embodiments, a backup power source (not shown in FIG. 2), such as a battery, supplies NVS with sufficient power to retain the data stored therein in case of power loss to data storage system 204. In certain embodiments, the capacity of NVS is less than or equal to the total capacity of cache 265.

The storage controller 228 includes a control switch 266 for controlling the communication protocol such as a fiber channel protocol, for example, to the host computers 210, 220, 225. Buffers 267 assist the cache 265 in temporarily storing (buffering) read and write data.

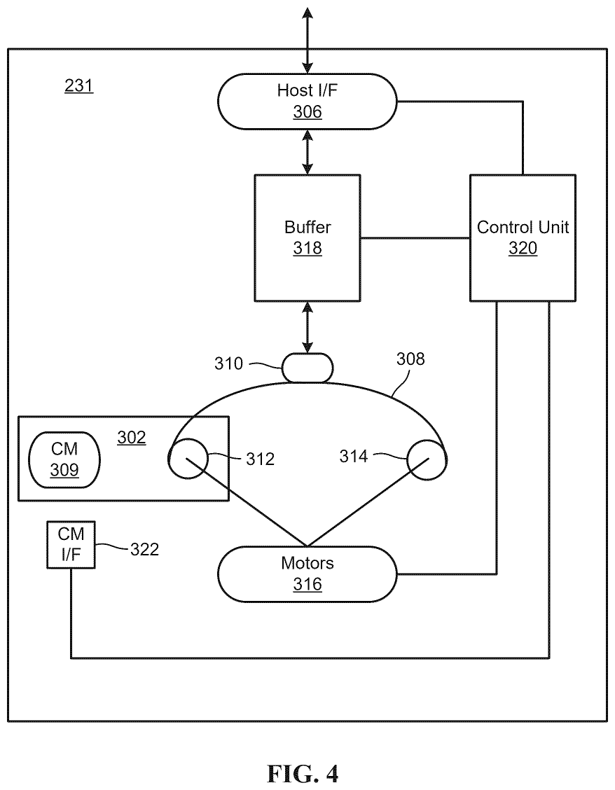

FIG. 4 is a block diagram depicting an example tape data storage drive 231 according to embodiments of the present disclosure. The tape data storage drive 231 comprises a removable data storage tape cartridge 302 and a communication interface (e.g., host data processing system interface (I/F) 306) to communicatively couple tape data storage drive 231 to the storage controller 228 (FIG. 3) or alternatively, one or more host data processing systems or associated communication channels (e.g., SAN interconnect 112).

The communication I/F 306 is configured to receive input/output (I/O) operation requests (e.g., “read” and/or “write” requests), and process such requests in an appropriate manner to control or “manage” access to a tape data storage medium 308 (e.g., magnetic tape) of removable data storage tape cartridge 302 as described herein. In addition to tape data storage medium 308, data storage tape cartridge 302 comprises a cartridge memory (CM) 309 which in one embodiment, includes a passive, contactless silicon storage device utilized to store data about the tape cartridge 302 in which it resides. Exemplary data may include, for example, data indicating the associated tape cartridge's volume serial number (VOLSER), the “type” of data storage medium within the cartridge, data format type and the data, if any, which is stored thereon.

Tape data storage medium 308 of removable data storage tape cartridge 302 is routed in proximity to a tape access (e.g., read/write) head 310 utilizing media transport reels 312 and 314 and one or more media transport motors 316 as shown. The tape access head 310 is configured to read data from and write data to tape data storage medium 308 and to temporarily store or “stage”such data within a buffer 318 (e.g., one or more “read-ahead” or staging buffers).

When writing data on a tape 308 (FIG. 3) or reading data from a tape 308, the tape 308 is moved relative to the read/write head 310 to the position of the data to be written or read in advance. The process of moving to the target data position is typically referred to as a “reposition” process and is performed in response to a reposition request issued by a storage controller.

In an example embodiment, tape cartridge 302 meets the standard specifications of one or more of a TS11xx tape drive such as, for example, the TS1160 or a LTO generation standard such as, for example, the LTO-7 tape drive. In such an embodiment, supply reel 312 may be a part of the tape cartridge and connected to beginning of the tape 308, and the end of tape 308 is connected to a leader pin (not shown) which is mechanically grasped by features (not shown) of tape data storage drive 231 and threaded onto take-up reel 314.

A control unit 320 includes read logic and write logic for reading data from and writing data to the tape of the tape storage drive. Thus, the control unit 320 controls and manages data flow, formatting, and data storage subsystem operation via control signals issued to one or more of communication I/F 306, buffer 318, media transport motors 316, and/or CM I/F 322 utilized to access (read or write) data stored in CM 309.

In the illustrated embodiment some or all of the functions of the tape reposition logic 257 (FIG. 2) may be located within the control unit 320 of the tape storage drive 231. In another embodiment, such control functionality may be incorporated into one or more of other components of the tape data storage drive 231. In a similar manner, although the control unit 320 is depicted in FIG. 3 as a part of a tape storage drive 231, it is appreciated that logic of the control unit may be located in one or more of various components of the system such as one or more of the storage controller 228, a host 210-225, and network 226, as well as the tape storage drive 231. Alternatively, some or all of the component functions may be implemented in hardware devices, such as in Application Specific Integrated Circuits (ASICs), Field Programmable Gate Array (FPGA) or executed by separate dedicated processors.

Control unit 320 may be configured to use cartridge memory 309, via cartridge memory reader or interface 322, to store information regarding the use of the magnetic tape medium 308 such as TD and FID information. Control unit 320 may be configured to perform the one or more of the methods described herein for reading and writing data.

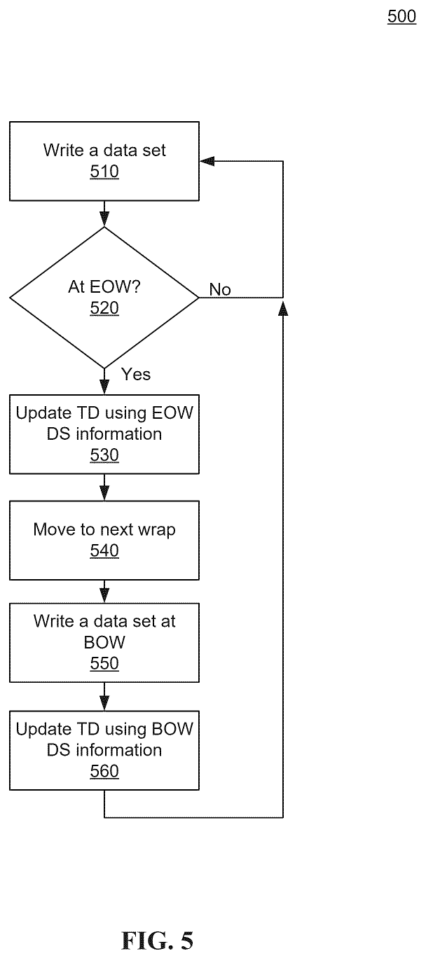

Referring now to FIG. 5, a flowchart of an example method 500 for BOW data set writing to tape is depicted. Method 500 may be performed by a tape drive. For example, one or more operations of method 500 may be performed by a control unit of the tape drive, such as control unit 320.

At operation 510, the tape drive writes a data set to tape. At operation 520, the tape drive determines whether has reached EOW for the wrap. If, at operation 520, the tape drive is not at EOW, the tape drive returns to operation 510 and writes another data set to tape. If, at operation 520, the tape drive is at EOW for the wrap, the tape drive proceeds to operation 530.

At operation 530, in response to reaching EOW for the wrap, the tape drive updates the TD with data set information for the data set written at EOW. The data set information may include a Data Set ID and Tape Write Pass for the data set written at EOW. In some embodiments, an identification flag may also be set to indicate that the data set information is for a data set written at EOW.

At operation 540, the tape drive to the next wrap. At operation 550, the tape drive writes the next data set at BOW of the wrap. The tape drive may write the data set at BOW using normal write criteria instead of append criteria. That is, the tape drive may write the data set without following rule-2 discussed previously.

At operation 560, the tape drive updates the TD using data set information for the data set written at BOW. In some embodiments, the tape drive may overwrite the data for the data set written at EOW. The tape drive may update the TD to include a Data Set ID and Tape Write Pass for the data set written at BOW. The tape drive may further set an identification flag to indicate that the data set information is for a data set written at BOW. After updating the TD, at operation 560, the tape drive may return to operation 510 and write the next data set to tape.

During method 500, the tape drive updates the Data Set ID and the Tape Write Pass twice during each run through operations 510-560. This allows for the TD to maintain consistency when a data set cannot be written at the BOW of the next wrap, for whatever reason, after writing a data set at EOW successfully.

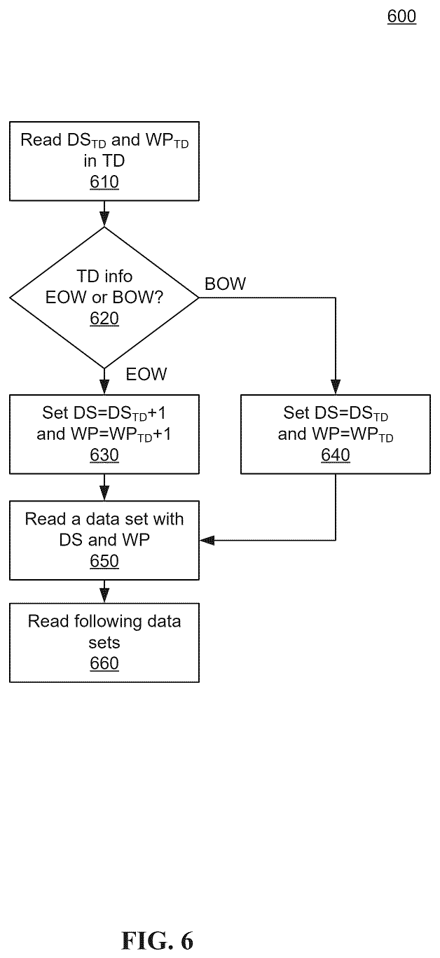

Referring now to FIG. 6, a flowchart of an example method 600 for reading data sets from BOW is depicted. Method 500 may be performed by a tape drive. For example, one or more operations of method 500 may be performed by a control unit of the tape drive, such as control unit 320.

At operation 610, the tape drive reads the Data Set ID and Tape Write Pass from an entry in the TD.

At operation 620, the tape drive determines whether the Data Set ID and Tape Write Pass from operation 610 corresponds to a data set at EOW of the previous wrap or BOW of the next wrap. In some embodiments, this may include determining whether an Identification Flag in the TD indicates that the corresponding data set was written at EOW or BOW.

If, at operation 620, the tape drive determines that the Data Set ID and Tape Write Pass corresponds to a data set at BOW, the tape drive sets the target Data Set ID and target Tape Write Pass for the read to the Data Set ID and Tape Write Pass read from the TD at operation 640.

If, at operation 620, the tape drive determines that the Data Set ID and Tape Write Pass corresponds to a data set at EOW, the tape drive sets the target Data Set ID to the Data Set ID from the TD incremented by one and the target Tape Write Pass to the Tape Write Pass from the TD incremented by one, at operation 630. For example, if the tape drive reads the Data Set ID as 8 and the Tape Write Pass as 3, the target Data Set ID may be set at 9 and the target Tape Write Pass may be set at 4.

At operation 650, the tape drive reads the data set at BOW using the target Data Set ID and Tape Write Pass set in operation 620 or operation 630.

At operation 660, the tape drive continues to read the following data sets.

When the CM cannot be read, the tape drive may read the BOW data set using the existing mechanism. The tape drive may perform skimming within 4 meters of the BOW to determine the Tape Write Pass of the data set written at BOW. Then, the tape drive may read the data set using the determined Tape Write Pass. Skimming is an operation to find the largest Tape Write Pass among data set fragment headers with the same data set umber which are read within 4 meters.

FID is the first data set written at the beginning of each partition and its data set number is 0. The Tape Write Pass of the FID is stored in a page dedicated for FID in the CM. The information is read from the CM when the tape is loaded to the tape drive and used by the tape drive to read the FID from the tape.

In existing tape drives, the tape drive appends FID at BOW of the first wrap. If the tape drive cannot append FID to the tape, the operation reports a permanent error to the host.

According to embodiments of the present disclosure, the FID is written using normal write procedure instead of following append rules. This means that it is not necessary for the tape drive to write a predefined number of COs continuously from BOW of the first wrap. Thus, the tape drive can write the FID within 4 meters from BOW by skipping bad condition areas on the tape. If the tape drive cannot write FID within 4 meters from BOW, it may increase the Tape Write Pass by one and repeat writing FID from BOW. Once the FID is written successfully, the Tape Write Pass of the FID page in CM is updated. If the FID write fails regardless of write retries, the tape drive may return a permanent error to the host.

The tape drive reads the FID from BOW of the first wrap using data set ID 0 with the Tape Write Pass which is stored in the FID page in the CM. If the tape drive cannot access the CM so that the Tape Write Pass of the FID cannot be retrieved, the tape drive may perform skimming within 4 meters from BOW of the first wrap to determine the Tape Write Pass.

Aspects of the present disclosure provide several benefits over prior art tape drives. In prior art tape drives, the tape drive appends a data set from BOW. When the tape is not degraded, the tape drive can write the data set without any problems. But, if the tape medium starts to become degraded, the tape drive cannot always start writing the data set to the tape medium from BOW. In this case, the tape drive repeats the append operation several times. If the tape drive cannot append the data set from BOW regardless of the repeated operations, it performs Suspended Append Write (SAW). If there is an empty entry in the SAW page in the CM, the tape drive starts writing the data set without following the append criteria to the tape after storing the data set number and tape write pass of the data set to the SAW entry. The probability to write the data set successfully becomes larger than with append criteria because normal write procedure allows bad areas in the tape medium to be skipped and completes writing the data set within 4 meters of BOW. It takes around 30 seconds to repeat several append operations and repeating the append operations can further promote degradation of the tape medium. If the drive cannot write the data set using SAW or there is no entry available in the SAW page of the CM, the drive returns an error to the host.

According to embodiments of the present disclosure, the tape drive initially writes the data set without following append rules when it writes a data set from BOW. Thus, the tape drive can skip degraded areas on the tape surface and complete writing of the data set within 4 meters of BOW. Additionally, no append operation retry is required like with prior art tape drives. If the tape medium is degraded such that it prevents the append operation from being successful but can successfully be written to by skipping the degraded area, then the tape drive according to embodiments of the present disclosure can write data sets at BOW faster and reduce further damage to the tape surface by reducing the number of append retries when compared to prior art tape drives.

In prior art tape drives, if the tape drive reaches the EOW of wrap n and turns to wrap n+1, the tape drive starts reading from BOW with a Tape Write Pass which is calculated by adding 1 to the Tape Write Pass of the data set at EOW of wrap n. If no write retry occurs when the tape drive appends a data set from BOW of wrap n+1, the tape drive can read the data set using a Tape Write Pass determined by adding 1 to the Tape Write Pass of the EOW data set of wrap n. Even when append was retried at BOW and the Tape Write Pass of the data set at BOW of wrap n+1 becomes larger than the Tape Write Pass of the data set at EOW by 2 or more, the tape drive can still read the data set because it is written by following the append rule.

According to embodiments of the present disclosure, the Tape Write Pass of the data set written at BOW of wrap n+1 is stored in the TD. Thus, the tape drive can read the data set from BOW of wrap n+1 using the Tape Write Pass stored in the TD independent of the Tape Write Pass of the data set at EOW of wrap n.

Additionally, embodiments of the present disclosure save space in the SAW page in the CM. The size of the CM is small and the space assigned to the SAW page is limited. Embodiments of the present disclosure can write data sets from BOW without using the SAW page in CM. This allows the tape drive to increase the number of SAW writes that can occur at locations other than BOW.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for beginning of wrap (BOW) data set writing to tape, the method comprising:
in response to reaching an end of wrap (EOW) while writing to tape, updating a tape directory (TD) to include first data set information for a first data set written at the EOW of a first wrap;
writing a second data set using normal write procedure from a BOW of a second wrap, the second wrap following the first wrap; and
overwriting, in the tape directory, the first data set information for the first data set written at the EOW with second data set information for the second data set written at BOW.

2. The method of claim 1, wherein the first data set information comprises a first Tape Write Pass and first Data Set ID for the first data set.

3. The method of claim 2, wherein the first data set information further comprises a first Identification Flag identifying the first data set information as associated with an EOW data set.

4. The method of claim 3, wherein the second data set information comprises a second Tape Write Pass and a second Data Set ID for the second data set, and wherein the second data set information further comprises a second Identification Flag identifying the second data set information as associated with a BOW data set.

5. The method of claim 2, wherein the second data set information comprises a second Tape Write Pass and second Data Set ID for the second data set.

6. The method of claim 5, further comprising setting an Identification Flag identifying the second data set information as associated with a BOW data set.

7. A method for reading a data set from beginning of wrap (BOW) from tape, the method comprising:
reading data set information from a tape directory (TD), the data set information including a first Data Set ID and first Tape Write Pass;
in response to determining that the data set information corresponds to a BOW data set, setting a target Data Set ID to the first Data Set ID and a target Tape Write Pass to the first Tape Write Pass; and
reading the BOW data set from tape using the target Data Set ID and the target Tape Write Pass.

8. The method of claim 7, wherein determining that the data set information corresponds to a BOW data set comprises reading an Identification Flag from the TD.

9. The method of claim 7, further comprising:
reading second data set information from the TD, the second data set information including a second Data Set ID and second Tape Write Pass;
in response to determining that the second data set information corresponds to an EOW data set, setting a second target Data Set ID to the second Data Set ID incremented by one and a second target Tape Write Pass to the second Tape Write Pass incremented by one; and
reading a second BOW data set from tape using the second target Data Set ID and the second target Tape Write Pass.

10. A tape storage system comprising a tape drive, the tape drive configured to perform operations comprising:
in response to reaching an end of wrap (EOW) while writing to tape, updating a tape directory (TD) to include first data set information for a first data set written at the EOW of a first wrap;
writing a second data set using normal write procedure from a BOW of a second wrap, the second wrap following the first wrap; and
overwriting, in the tape directory, the first data set information for the first data set written at the EOW with second data set information for the second data set written at BOW.

11. The system of claim 10, wherein the first data set information comprises a first Tape Write Pass and first Data Set ID for the first data set.

12. The system of claim 11, wherein the first data set information further comprises a first Identification Flag identifying the first data set information as associated with an EOW data set.

13. The system of claim 12, wherein the second data set information comprises a second Tape Write Pass and a second Data Set ID for the second data set, and wherein the second data set information further comprises a second Identification Flag identifying the second data set information as associated with a BOW data set.

14. The system of claim 11, wherein the second data set information comprises a second Tape Write Pass and second Data Set ID for the second data set.

15. The system of claim 14, wherein the operations further comprise setting an Identification Flag identifying the second data set information as associated with a BOW data set.

16. The system of claim 10, wherein the operations further comprise:
reading third data set information from the TD, the data set information including a third Data Set ID and third Tape Write Pass;
in response to determining that the third data set information corresponds to a BOW data set, setting a target Data Set ID to the third Data Set ID and a target Tape Write Pass to the third Tape Write Pass; and
reading a second BOW data set from tape using the target Data Set ID and the target Tape Write Pass.

17. The system of claim 16, wherein determining that the third data set information corresponds to a BOW data set comprises reading an Identification Flag from the TD.

18. The system of claim 16, wherein the operations further comprise:
reading fourth data set information from the TD, the fourth data set information including a fourth Data Set ID and fourth Tape Write Pass;
in response to determining that the second data set information corresponds to an EOW data set, setting a second target Data Set ID to the fourth Data Set ID incremented by one and a second target Tape Write Pass to the fourth Tape Write Pass incremented by one; and
reading a third BOW data set from tape using the second target Data Set ID and the second target Tape Write Pass.
